(19) United States
(12) Patent Application Publication
(10) Pub. No.: US 2020/0370710 A1
(43) Pub. Date: Nov. 26, 2020

(54) Thermal Cascade for Cryogenic Storage and Transport of Volatile Gases

(71) Applicant: Edward Peterson, Pearland, TX (US)

(72) Inventor: Edward Peterson, Pearland, TX (US)

(21) Appl. No.: 16/959,794

(22) PCT Filed: Jan. 10, 2019
(86) PCT No.: PCT/US19/12966

§ 371 Date: Jul. 2, 2020

Related U.S. Application Data
(60) Provisional application No. 62/616,849, filed on Jan. 12, 2018.

(51) Int. Cl. F17C 7/04

(52) U.S. Cl. CPC F17C 7/04; F17C 2223/0161; F17C 2227/0341; F17C 2221/011; F17C 2227/0135; F17C 2221/017; F17C 2221/033; F17C 2221/035; F17C 2221/013; F17C 2221/014

(57) ABSTRACT

A system is described wherein a cryogenic liquid transport fluid is used as in thermal communication with a volatile gas as a second cryogenic liquid. The volatile gas in the liquid state enables transport of additional volatile substances that cannot be transported in the liquid state employing only the cryogenic liquid. The thermal communication between cryogenic liquids is a thermal cascade.

### RELATED APPLICATIONS

This application claims priority to U.S. Provisional Application No. 62/616,849 filed Jan. 12, 2018, the entire contents of which are incorporated by reference herein.

### FIELD OF THE DISCLOSURE

This disclosure relates to a system for transporting multiple volatile gases in a cryogenic liquid carrier fluid. More specifically, the disclosure relates to a volatile gas in a cryogenic liquid state that enables transport of additional volatile substances in thermal communication with the cryogenic liquid.

### BACKGROUND

Transportation of valuable, volatile chemicals as pure substances or as certain mixtures under pressure is commercial practice. Generally, this pressure containment adds weight and cost to the transportation of a chemical. Refrigeration of volatile chemicals lowers the working pressure needed to transport a chemical gas and reduces the need for pressure containment. Refrigeration equipment systems add expense to the transportation of volatile chemicals and risk of refrigeration equipment failure, particularly for compressor based systems. If a volatile chemical escapes pressure containment or a refrigerated chemical warms to ambient temperature, it poses a significant risk to the transportation vehicle, operators, and local environment.

The transportation of liquefied natural gas (LNG) is a commercially established industry that replaces compressors with other pump configurations. Various publications have described the storage and transport of LNG, mixtures of LNG, and optionally containing minor amounts of a gas impurity as a liquid mixture at cryogenic temperatures, below about −150° C. (−258° F.). Others have described the implementation of a LNG as a carrier or transport fluid for intentionally introduced, high concentrations of a single selected gas impurity or dopant. A gas dopant is typically one other commercially valuable, volatile gaseous compound that is heavier than methane. The gas dopant admixed into a transport fluid such as LNG under cryogenic conditions has a reduced toxicity or explosive potential in this configuration. However, there are thermodynamic and chemical limitations to the number and types of gas dopants that may be admixed into a transport fluid for transportation.

### SUMMARY

A method for storage and transporting gases is disclosed herein, comprising the steps of charging a transport fluid to a transport fluid system at cryogenic conditions, charging a first volatile gas to a first volatile gas system, maintaining the first volatile gas in a first liquid phase by heat transfer with the transport fluid, charging a second volatile gas to a second volatile gas system, maintaining the second volatile gas in a second liquid phase by heat transfer with the first volatile gas or the transport fluid, and transporting the first and second liquid phases.

The transport fluid comprises at least one component chosen from the group consisting of oxygen, nitrogen, argon, methane, ethane, ethylene, propane, propylene and combinations thereof.

The first volatile gas or the second volatile gas may comprise oxygen, carbon monoxide, argon, propane, propylene, 1-butene, silane, tetrafluoromethane, ethane, liquid natural gas, methane, monochlorotrifluoroethane, chlorotrifluoromethane, ethylene chlorodifluoromethane, chlorodifluoromethane, isobutane, krypton, trifluoromethane, vinyl chloride, perfluoroethene, tetrafluoroethylene, dimethyl ether, isobutene, n-butane, methyl ethyl ether, carbonyl sulfide, chloro-2-difluoro-1,1-ethylene, difluoromethane, dichloromonoflurormethane, phosphine, neopentane, phosgene, acetaldehyde, difluoroethane, chloro-1-tetrafluoro-1,1,2,2-ethane, hydrogen chloride, xenon, ethylene oxide, 1,1,1-trifluoroethane, 1,2-butadiene, 1,3-butadiene, dichlorodifluoroethane, chloro-2-trifluoro-1,1,1-ethane, chlorine, 1,1,1,2-tetrafluoroethane, hexafluoroethane, methyl chloride, methyl bromide, formaldehyde, dinitrogen oxide, hydrogen sulfide, hydrogen fluoride, methyl fluoride, ammonia, pentafluoroethane and combinations thereof. In certain configurations, the transport fluid comprises oxygen, nitrogen, argon, liquid natural gas, methane, ethane, ethylene, propane, propylene and combinations thereof.

The transport fluid, first volatile gas, and second volatile gas are maintained in separate liquid phases by a cryogenic thermal cascade.

### BRIEF DESCRIPTION OF THE DRAWINGS

For a detailed description of the preferred embodiments of the invention, reference will now be made to the accompanying drawings in which:

FIG. 1 illustrates a schematic of thermal cascades in the present disclosure.

FIG. 2 illustrates a schematic of direct thermal cascades in the present disclosure.

FIG. 3 illustrates a schematic of indirect thermal cascades in the present disclosure.

FIG. 4 illustrates an indirect thermal cascade system for cryogenic gas storage and transport according to the present disclosure.

FIG. 5 illustrates a table of representative chemical compounds that may be transported as a first or a second volatile gas liquid with an LNG transport fluid.

FIG. 6 illustrates a table of the representative chemical compositions that may be co-transported with various first volatile gases with an LNG transport fluid.

FIG. 7 illustrates a table of representative chemical compounds that may be transported as a first or second volatile gas liquid with an ethane transport fluid.

### DETAILED DESCRIPTION

The production of certain volatile gases and their consumption as a reactant for an industrial process require overland or marine transportation. Volatile gases are transported under pressure containment, at refrigerated temperatures, or combinations thereof. Safety and infrastructure constraints negatively impact shipping costs and potential markets for these gases. For example, large-volume pressurized shipping containers are heavy and some compounds cannot be transported to certain markets due to the potential for unintentional depressurization release, resulting in a public hazard. Also, large volume refrigerated shipping containers require refrigeration and compressor infrastructure both during transportation and unloading that some markets may not be able to accommodate sufficiently to receive and store certain compounds.

A method of arranging a direct or an indirect thermal cascade between a transportation fluid and a volatile gas offers a means to reduce costs associated with storage and transportation containment and infrastructure. A thermal cascade is the arrangement of heat transfer between a volatile gas and a transportation fluid. The transportation fluid is utilized as a heat transfer medium to keep a volatile gas within a predetermined temperature range. A thermal cascade is configured such that the transportation fluid is cooled to a liquid state. The thermal cascade is configured to keep the transportation fluid and the volatile gas in a liquid state. The transportation fluid is cooled to a liquid state at a cryogenic temperature. Cryogenic temperatures as used herein may refer to any temperature below about −90° C. (−130° F.), alternatively any temperature below about −120° C. (−184° F.), and alternatively any temperature below about −150° C. (−238° F.).

The transportation fluid is a pure or substantially pure gaseous composition at standard temperature and pressure (STP), defined herein as 0° C. (32° F.) and 1 atm (101.325 kPa). The transport fluid gaseous composition is a liquid at cryogenic temperatures, without additional pressurization, for example at standard pressure of 1 atm (101.325 kPa). The transport fluid may be any fluid kept under cryogenic temperatures with low pressurization, for example at a pressure of less than about 5 atm (506.625 kPa), alternatively at a pressure of less than about 3 atm (303.975 kPa), and in some instances, at a pressure of less than about 2 atm (202.650 kPa).

The transport fluid may be considered a pure or substantially pure gaseous composition at STP if at least about 85% concentration by volume is a single gas component; alternatively, at least about 90% concentration by volume is a single gas component; or at least about 95% concentration by volume is a single gas component. In certain instances, the transport fluid is considered pure or substantially pure if at least about 99% concentration by volume is a single gas component at STP. A transport fluid may be any pure or substantially pure gas component that is at least 85% liquid by volume at cryogenic temperatures; alternatively at least 90% liquid by volume; or at least 95% liquid by volume at cryogenic temperatures depending on composition. A transport fluid may also be any composition that is at least 99% liquid by volume at cryogenic temperatures.

The volatile gas may be considered a pure or substantially pure gaseous composition according to the definitions presented for the transport fluid. The volatile gas may comprise one or more pure or substantially pure gases that are mixed. In mixed gas component instances, a volatile gas may have any ratio of mixed components between a first gas and a second gas and for example, a ratio of first gas to second gas can range from about 1:1000 to about 1000:1. Any gas component that is mixed into another may be considered an impurity or dopant. This includes multiple components mixed to form a volatile gas and any volatile gas that is mixed into a transport fluid. Mixing of volatile gases or transport fluid may be in the gas or liquid phase.

The volatile gas has a boiling point, or temperature of phase change from liquid to gas, that is lower than the boiling point of the transport fluid at STP. The volatile gas has a freezing point that is lower than the boiling point of the transportation fluid. In mixed volatile gas configurations, a first gas may be used as a heat transfer medium between the transportation fluid and a second gas, such that the first gas and the second gas are kept within predetermined temperature ranges. In instances, the predetermined gas temperature range is cryogenic or alternatively the temperature range is lower than the boiling point of a volatile gas.

While not outside the envisioned scope of the present disclosure, there are thermal cascade configurations that may be unfavorable to transport a volatile gas in a transport fluid. More specifically, it may be unfavorable when the volatile gas has a freezing point above the boiling point of a transport fluid, resulting in a volatile gas solid or the boiling point of the volatile gas that is below the boiling point of the transportation fluid and resulting in a volatile gas. Transporting volatile gases in the solid or gaseous state may require additional, duplicate, or alternative heat transfer media or process steps from those found herein.

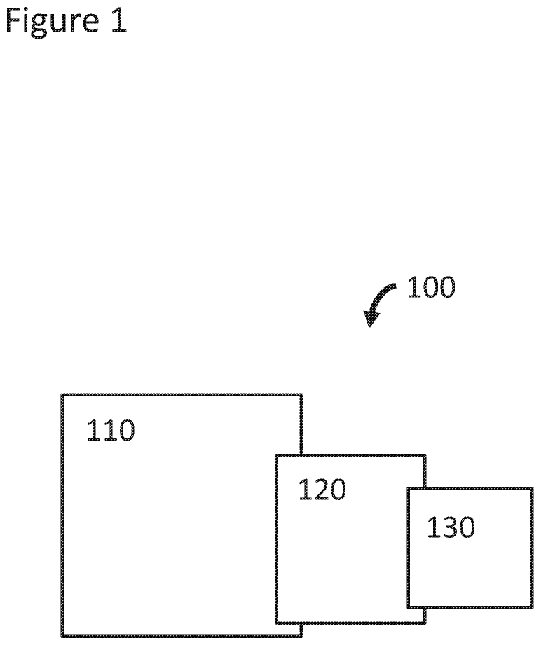

FIG. 1 schematically illustrates a thermal cascade 100 between a transport fluid 110 and a volatile gas 120. The transport fluid 110 is maintained at a cryogenic temperature. The volatile gas 120 is in thermal communication with the transport fluid 110. The volatile gas 120 is maintained at a cryogenic temperature by the thermal communication with the transport fluid 110. The volatile gas 120 is maintained at a temperature below its boiling point by heat transfer to the transport fluid 110. Transport fluid 110 is a heat transfer medium for the volatile gas 120.

In some configurations, the volatile gas 120 may also be in thermal communication with a second volatile gas 130. In these configurations, the volatile gas 120 may be considered a first volatile gas 120. The transport fluid 110 is maintained at a cryogenic temperature. The first volatile gas 120 is in thermal communication with the transport fluid 110 is maintained at a predetermined temperature below its boiling point and optionally at a cryogenic temperature. The second volatile gas 130, in thermal communication with the first volatile gas 120, is thus maintained at a temperature below its boiling point and optionally at a cryogenic temperature. Transport fluid 110 is a heat transfer medium to the first volatile gas 120 and the second volatile gas 130. The first volatile gas 120 is a heat transfer medium to the transport fluid 110 from the second volatile gas 130. The thermal communication between the transport fluid 110 and any volatile gases, such as the first volatile gas 120 and the second volatile gas 130, forms a thermal cascade 100.

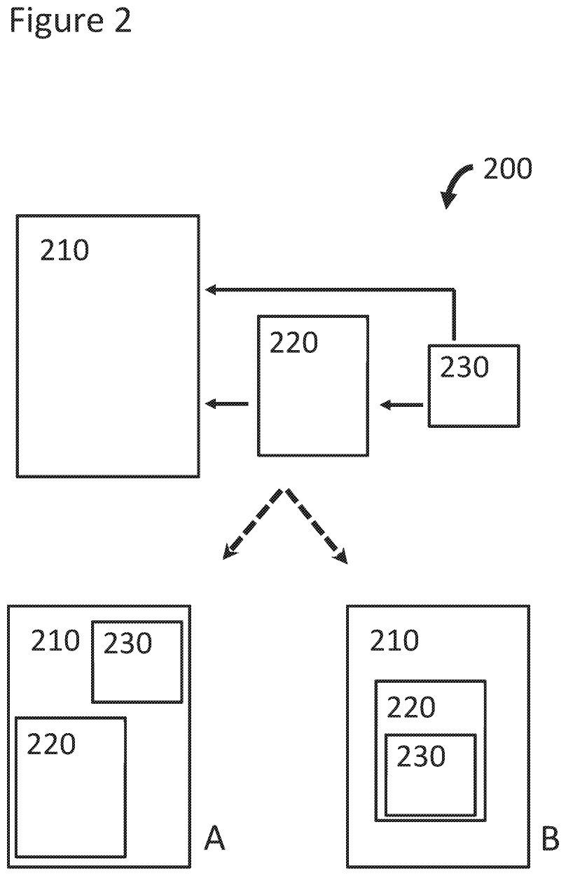

Referring now to FIG. 2, the thermal cascade 200 may result from the direct heat transfer between the transport fluid 210, the first volatile gas 220, and the second volatile gas 230. A direct heat transfer configuration comprises admixing a volatile gas directly into the transport fluid 210 in a single container or vessel. The first volatile gas 220 is admixed into the transport fluid 210, in the gas phase, the liquid phase, or combinations thereof. The first volatile gas 220 may be considered an impurity or a dopant in the transport fluid 210. Also, the second volatile gas 230 may be admixed directly into the transport fluid 210 in the gas phase, the liquid phase, or combinations thereof. This may be simultaneous or sequential with directly admixing the first volatile gas 220 into the transport fluid 210. The second volatile gas 230 may also be considered an impurity or a dopant in the transport fluid 210. Further, the second volatile gas 230 may be considered a high boiling liquid gas. Schematically, this may represented by thermal cascade A.

Alternatively, the second volatile gas 230 may be directly admixed into the first volatile gas 220, in the gas phase, the liquid phase, or combinations thereof. The second volatile gas 230 may be considered a high boiling liquid gas, an impurity, or a dopant in the first volatile gas 220. The admixed second volatile gas 230 and first volatile gas may then be directly admixed into the transport fluid 210 in the gas phase, the liquid phase, or combinations thereof. The first volatile gas 220 may completely surround and isolate the second volatile gas 230 from the transport fluid 210. Further, the second volatile gas 230 may be considered a high boiling liquid gas. Schematically, this may represented by thermal cascade B.

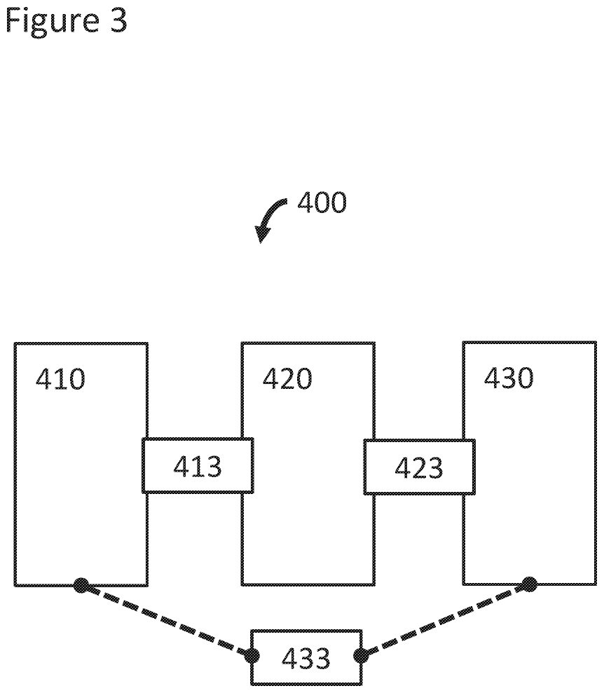

FIG. 3 illustrates an indirect thermal cascade 400. Indirect heat transfer refers to the exchange of thermal energy without admixing gas components into a single container or vessel. The thermal energy is transferred by heat transfer devices such as vessels, conduits, heat exchangers, other equipment, or infrastructure systems. As such, the transportation fluid system 410, the first volatile gas system 420, and the second volatile gas system 430 maintain gases that are isolated, sealed, or otherwise prevented from mixing. The transportation fluid system 410, the first volatile gas system 420, and the second volatile gas system 430 are configured independently with the exception of a shared heat transfer step between each system. A heat transfer step may be any heat exchanger configuration that keeps a cryogenic liquid, a volatile gas liquid, or gas thereof in separated, sealed conduits. More specifically, the transportation fluid system 410 is in thermal communication with a first volatile gas system 420 by a thermal transfer step 413. The second volatile gas system 430 is in thermal communication with the first volatile gas system 420 by a thermal transfer step 423. In certain configurations, the second volatile gas system 430 is in thermal communication with the transportation fluid system 410 by a thermal transfer step 433.

Transport fluids 110, 210, first volatile gases 120, 220 and second volatile gases 130, 230 may be any volatile gas component, providing a thermal cascade arrangement. Thus, transport fluids 110,210, first volatile gases 120,220 and second volatile gases 130,230 may comprise oxygen, carbon monoxide, argon, propane, propylene, 1-butene, silane, tetrafluoromethane, ethane, liquid natural gas, methane, monochlorotrifluoroethane, chlorotrifluoromethane, ethylene chlorodifluoromethane, chlorodifluoromethane, isobutane, krypton, trifluoromethane, vinyl chloride, perfluoroethene, tetrafluoroethylene, dimethyl ether, isobutene, n-butane, methyl ethyl ether, carbonyl sulfide, chloro-2-difluoro-1,1-ethylene, difluoromethane, dichloromonoflurormethane, phosphine, neopentane, phosgene, acetaldehyde, difluoroethane, chloro-1-tetrafluoro-1,1,2,2-ethane, hydrogen chloride, xenon, ethylene oxide, 1,1,1-trifluoroethane, 1,2-butadiene, 1,3-butadiene, dichlorodifluoroethane, chloro-2-trifluoro-1,1,1-ethane, chlorine, 1,1,1,2-tetrafluoroethane, hexafluoroethane, methyl chloride, methyl bromide, formaldehyde, dinitrogen oxide, hydrogen sulfide, hydrogen fluoride, methyl fluoride, ammonia, pentafluoroethane and combinations thereof. In certain configurations, the transport fluid 110, 210 comprises oxygen, nitrogen, argon, liquid natural gas, methane, ethane, ethylene, propane, propylene and combinations thereof.

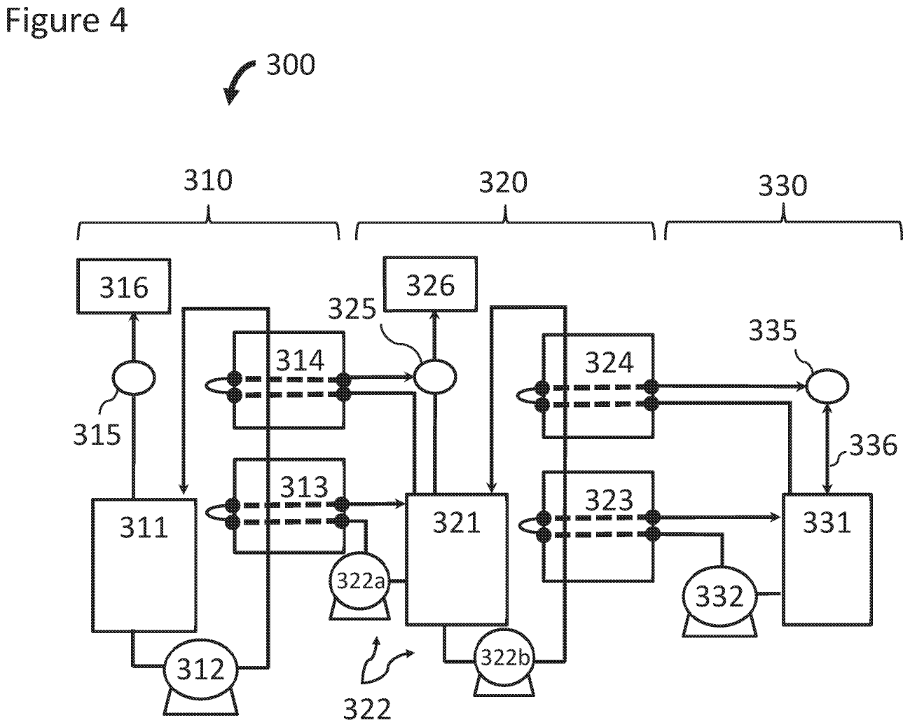

Referring now to FIG. 4, there is illustrated a system 300 for the indirect thermal cascade during cryogenic gas storage and transport. Generally, the system 300 comprises a transportation fluid system 310, a first volatile gas system 320, and a second volatile gas system 330. The transportation fluid system 310 comprises a vessel 311, a pump fed conduit 312, a first heat exchanger 313, a second heat exchanger 314, a regulator 315, and boil-off system 316. The first volatile gas system 320 comprises a vessel 321, a pump fed conduit 322, a first heat exchanger 323, a second heat exchanger 324, a regulator 325, and a boil-off system 326. The second volatile gas system 330 comprises a vessel 331, a pump fed conduit 332, a regulator 335, and a recirculation system 336.

Generally, the vessels 311, 321, 331, are configured as volatile gas liquid storage vessels or cryogenic liquid storage vessels. Vessels 311, 321, 331, may comprise any refrigeration or cryogenic equipment, including without limitation pumps, compressors, condensers, coolant conduits, evaporative coolers, air coolers, water coolers, auto-refrigeration, or gas-expansion such that they are thermally regulated in a predetermined temperature range. The vessels 311, 321, 331 may be configured for pressure containment at any elevated pressure that is less than about 5 atm (506.625 kPa), when charged with a cryogenic liquid. The vessels 311, 321, 331 comprise any volume between about 0.0001 m³ and to about 500,000 m³, and in certain configurations the vessels comprise multiple individual vessels, containers, sections, chambers, baffles, honeycombs, conduits, or combinations thereof without limitation. The vessels 311, 321, 331 may have a dynamic volume that changes to accommodate the volume and pressure of a volatile gas liquid when charged, injected, or introduced therein. Likewise, the vessels 311, 321, 331 may have any size or volume to meet local storage or transportation demands. In the latter examples, sizes may range from less than liter of a volatile gas liquid for laboratory use or transportation about a research facility, to about the size of a railroad car or semi-truck for a manufacturing facility storage and supply or overland transportation thereto. The configuration of the vessels 311, 321, 331 may extended to about the size of any marine vessel, such as a marine gas tanker or a marine gas super-tanker.

Generally, pump fed conduits 312, 322, 332 withdraw a cryogenic liquid from the vessels 311, 321, 331, respectively. The pump fed conduits 312, 322, 332 comprise any conduit configured for conveying a cryogenic liquid or a volatile gas liquid, including but not limited to any material and any insulation acceptable for maintaining the volatile gas in a liquid phase or at a cryogenic temperature. The pump fed conduits 312, 322, 332 further comprise any apparatus or device configured to provide motive force to a volatile gas liquid, such as but not limited to a compressor pump, a reciprocal pump, or a centrifugal pump. The pump fed conduits 312, 322, 332 may convey a volatile gas liquid from point to point, or they may be configured to form a circuit that begins and ends in the vessels 311, 321, 331, respectively. In exemplary configurations, it may be envisioned that there are multiple pump fed conduits originating from and returning to a vessel. For example, first volatile gas system 320, comprising vessel 321, has a first pump fed conduit 322a and a second pump fed conduit 322b. While only this embodiment is shown in the FIG. 2, similar configurations of pump fed conduits 312, 332 for vessels 311, 331 found respectively in the transportation fluid system 310 and the second volatile gas system 330 are within the envisioned scope of this disclosure.

The pump fed conduits 312, 322, 332 convey the volatile gas liquid or cryogenic fluid to the first heat exchangers 313, 323 and the second heat exchangers 314, 324. The first heat exchangers 313, 323 may be any heat exchanger configured for liquid to liquid thermal transfer between volatile gas liquids or cryogenic fluids. The second heat exchangers 314, 324 may be any heat exchanger configured for vapor or gas to liquid heat transfer. First heat exchangers 313, 323 and second heat exchangers 314, 324 may be of any design such that heat exchange can occur through indirect means when acting upon cryogenic fluid or volatile gas liquid streams comprising liquids, gases, solids, or combinations thereof. Additional heat exchangers may be utilized in the pump fed conduits 312, 322, 332 as needed to configure a thermal cascade for system 300.

Regulators 315, 325, 335 are configured to regulate the vapor or pressure in the vessels 311, 321, 331 respectively. Regulators 315, 325, 335 may be a gas or vapor flow to keep the vapor flowing at a constant volume per time or pressure to maintain vessels 311, 321, 331 at a predetermined containment pressure. Additionally, regulators 315, 325, 335 may include configurations that permit counter directional flow of vapors and liquids, such that condensate returns to the respective vessel 311, 321, 331. Regulator 335 controls vapor from second volatile gas vessel 331 in recirculation conduit 336. Recirculation conduit 336 circulates and condenses vapors for return to the second gas vessel 331. Regulators 315, 325 disposed in the transportation fluid system 310 and the first volatile gas system 320, control the vapor flow to the boil-off systems 316, 326 respectively.

Boil-off systems 316, 326 may comprise any system configured to capture or maintain containment of a vapor that has boiled off of a volatile liquid gas or cryogenic fluid. Boil-off systems 316, 326 may comprise compressors, pumps, or refrigeration systems that condense the vapors to reform a liquid gas. Boil-off systems 316, 326 may comprise a fuel supplementations system that captures the vapors for use as a fuel or fuel additive in combustion or other energy processes, such as but not limited to refrigeration, motive transport, electricity production, water desalination and waste recycling. In certain circumstances, the boil-off systems 316, 326 may be configured to permit controlled release of certain predetermined vapors to the atmosphere.

In operation, the transport fluid (TF) is charged to the transport fluid system 310 under cryogenic conditions. A first volatile gas (VG1) is charged to the first volatile gas system 320 as liquid and a second volatile gas (VG2) is charged to the second cryogenic gas system 330 as a liquid. The transportation fluid is kept at cryogenic conditions to maintain a liquid state of the first volatile gas and the second volatile gas. Operation of the system, circulates the first volatile gas and the second volatile gas in thermal communication with transportation fluid, thus keeping them in a liquid state under cryogenic conditions.

In certain operations the transportation fluid is maintained in vessel 311, at or near its natural boiling point, for example under cryogenic conditions. Also, transport fluid may be maintained at a containment pressure defined by regulator 315. Transport fluid moves through pump fed conduit 312 to first heat exchanger 313. In certain instances, the first heat exchanger 313 acts as liquid to liquid heat exchanger. VG1 leaves vessel 321 via pump fed conduit 322a and flows through first heat exchanger 313. This permits thermal communication or heat transfer from VG1 in first volatile gas system 320 to transportation fluid in transportation fluid system 310. Heat exchange between the transport fluid and VG1 results in some vaporization of transport fluid and cooling of the VG1. Thus cooled, the VG1 is returned to vessel 321. The partially vaporized transport fluid may be returned to vessel 311.

In other operations, the partially vaporized transport fluid in pump fed conduit 312 flows to a second heat exchanger 314. The second heat exchanger 314 is a liquid vapor condenser. In the second heat exchanger 314, the transport fluid is further vaporized by VG1 vapor or boil off from vessel 321. The partially vaporized transport fluid from the second heat exchanger 314 is returned to the vessel 311.

As vapor accumulates in vessel 311, there may be an increase in gas pressure. Regulator 315 controls the release of transport fluid vapor from the vessel 311 to the boil off system 316. Transport fluid vapors can be utilized as a source of energy for multiple purposes, including, but not limited to refrigeration, motive transport, electricity production, water desalination and waste recycling.

In operations, the first volatile gas (VG1) contained as a liquid under cryogenic conditions in vessel 321. More specifically, it is envisioned that the VG1 is maintained at a temperature between that of the transport fluid in transportation fluid system 310 or vessel 311 and the temperature which would result from the first volatile gas boiling. The boiling point of the VG1 is controllable by pressure defined by a pressure control valve such as regulator 325. In certain configurations, if the VG1 containment pressure is maintained below the VG1 boiling point, no vapors will pass into the boil-off system 326. Alternatively, if the liquid in the vessel 321 of the first volatile gas system 320 is allowed to heat to a temperature and thus pressure that is higher than regulator 325 is configured to contain, the VG1 vapors will pass into the boil off system 326. Boil off system 326 may be configured identically, similar, connected, or in communication with boil off system 315 described herein. Alternatively, the first volatile gas vapors may be vented to atmosphere in predetermined situations for predetermined compositions. Still further, the VG1 vapors may be directed by regulator 325 to the second heat exchanger 314 as a vapor for condensing. As described here, the VG1 vapor in second heat exchanger 314, configured as liquid vapor condenser, is condensed by heat exchange with the transport fluid. The condensed VG1 is returned to the vessel 321.

A second volatile gas (VG2) may be co-transported in a second volatile gas system 330 that is in thermal communication with transport fluid system 310 and first volatile gas system 320. The VG2 may be considered a high boiling liquid (HBL). The VG2 is thusly in thermal communication or thermal cascade arrangement with and for co-transportation with the transport fluid and the VG1. In this configuration, VG2 is retained in vessel 331 as a liquid under cryogenic or refrigerated conditions as described here.

In operation, the VG2 is conveyed via pump fed conduit 332 to heat exchange 323. At or about the same time, the VG1 is conveyed via pump fed conduit 322b from the vessel 321 in the first volatile gas system 320 to the first heat exchanger 323. Generally, first heat exchanger 323 may be analogous to the first heat exchanger 313 in the transportation fluid system 310. The first heat exchanger 323 is configured as liquid-to-liquid heat exchanger. The first heat exchanger 323 permits thermal transfer between liquids at cryogenic or refrigerated temperatures. Configured thusly, the VG2 as a liquid transmits heat to the VG1 and may partially vaporize the VG1. The VG2 is condensed and returned to the second volatile gas system 330 and specifically vessel 331. The VG1, in liquid or partially vaporized phase, is returned to vessel 321.

In further operations, VG2 may increase in temperature and thus pressure in vessel 331. As such, the boiling point of VG2 may be controlled by regulator 335, as previously described. In instances where the VG2 is maintained at a pressure and temperature, such that vapor is produced in vessel 331. The VG2 vapor passes through regulator 335 and may be conveyed to a second heat exchanger 324. Second heat exchanger 324 may be analogous to the previously described second heat exchanger 314 in the transportation fluid system 310. The VG2 thermally exchanges heat with the partially vaporized VG1. The heat exchange that occurs in the second heat exchanger 324 results in condensation of VG2 vapor. The condensed VG2 is returned to vessel 331. The partially vaporized VG1 is returned to vessel 321 of the first volatile gas system 320.

In the operational processes described herein, transport fluid, first volatile gas, and second volatile gas may contain no vapor, no liquid, or a mixture of liquid and vapor, depending upon the properties of each and operation of the system 300. Still further, regulators 315, 325, 335 may operate at the same pressure, a lower pressure, or a higher pressure than any other regulator in the system. For example, regulators 315, 325, 335 are operated at independent and different pressures or at the same operating pressure. Pump fed conduits 312, 322, 332 will preferentially be designed to move liquids, particularly cryogenic liquids, but may be capable of partial or complete compression of gases.

Although not shown and described specifically, additional equipment can be utilized to provide cooling of specific streams utilizing refrigeration, evaporative cooling, air cooling and other sources of heat or cold which are not specifically cross-exchange of heat between the active fluids. All pressure control valves and operating valves may be manually operated, automatically operated or self-actuating. Although a controllable and safe operation is desired, no emergency equipment for maintaining pressure or temperature is specifically included or excluded at this time, but may be useful to prevent unsafe or undesirable conditions from developing within the equipment. It is also presumed that all liquids can be transferred into or out of any or all containment vessels shown herein, although such transfer equipment is not depicted in FIG. 4.

Referring now to FIG. 4 and FIG. 2, the controllable and safe operation of the system 300 may allow for intermingling of the first volatile gas with the second volatile gas, or the first volatile gas with the transportation fluid, the second volatile gas with the transportation fluid, or any combination thereof. It is envisioned that there will be circumstances where it is desirable that a low temperature transport fluid (TF) be utilized as the heat transfer medium in the liquid state. It is further sometimes desirable that the more volatile gas, the first volatile gas (VG1), be maintained in its liquid state, such that it does not form solid fractions at storage conditions. It is further desirable that the first volatile gas vapor pressure not exceed the pressure of containment at the controlled storage temperature. It is also understood that this invention is not limited to pure compounds or formulations. The transport fluid (TF) may be a pure compound or a mixture of compounds that has a desired boiling point or range at the desired operating pressure range of the system. The first volatile gas may be a mixture of compounds that as a mixture has a freezing point below that of the boiling point of the transport fluid, while having a boiling point at containment conditions above the boiling point of the transport fluid. In addition, a second volatile gas (VG2) may be a mixture of compounds or a pure substance that has a freezing point below that of the boiling point of the first volatile gas, while having a boiling point at containment conditions above or below the controlled temperature of the first volatile gas. In some cases, the boiling point of the second volatile gas will exceed the boiling point of the first volatile gas. In some cases, the boiling point of the second volatile gas will equal to or be lower than the boiling point of the first volatile gas. Although examples are contained within for a system of three distinct fluids, the number of fluids so contained could be greater. There is no limitation inferred as to the relative amounts of each fluid. The amount of one or more transport fluids needs to be great enough and no greater than adequate to move one or more first volatile gas and one or more second volatile gas as liquids from export location to import location taking into account expected losses due to vaporization to the environment and in some cases, its use as a source of transport fuel or power source for refrigeration. The amount of the first volatile gas needs to be only large enough to provide adequate cooling of and heat transfer away from the second volatile gas and may or may not consist of a saleable or valuable chemical for export. There may in some cases be versions of the first volatile gas and second volatile gas wherein the purpose of second volatile gas is to be a saleable product and that of the first volatile gas serves as a non-reactive heat transfer fluid. There may in some cases be multiple transport fluids, first volatile gas, and second volatile gas transported on the same overland transport or marine vessel. There may be cases wherein all substances are saleable but import locations are different for each material or portions of each substance or mixture made possible by the combined contents.

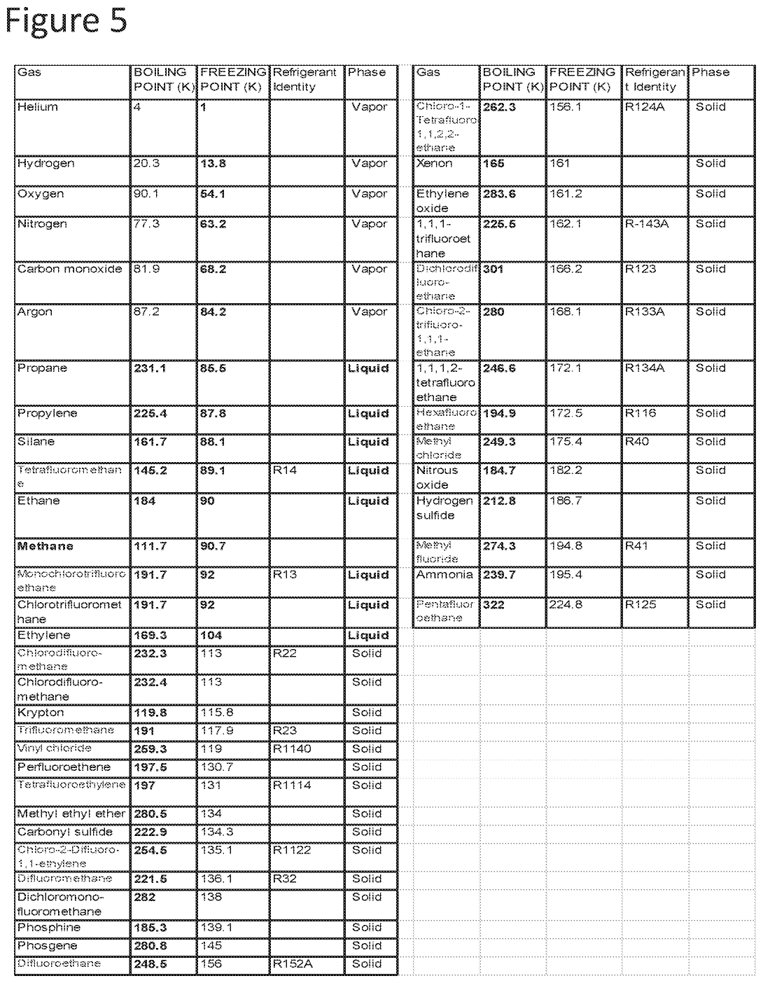

Referring to FIG. 5 there is shown a table of representative chemical compounds that may be shipped as a first or second volatile gas liquid (e.g., VG1, VG2). In these exemplary configurations, the transport fluid consists of or comprises liquid natural gas (LNG). The list of liquid volatile gases may be co-transported with the LNG in a thermally or cascade manner and system as discussed previously. The co-transported liquid volatile gases may be in direct or indirect thermal communication with the LNG, when implemented as a transportation fluid. Furthermore, the list of compounds is not exhaustive nor is the invention intended to be limited to this list of compounds, substances or their mixtures. The table of FIG. 5 is used for illustrative purposes only.

The LNG substantially comprises methane. It is also understood that impurities in the LNG which are not methane may be present. These other impurities can alter the boiling point and freezing point of the LNG. It is also understood that the pressure of containment of the co-transported compound will affect its boiling point. The pressure of transport can also change the boiling point of the LNG.

In general, FIG. 5 demonstrates the fluid properties of freezing point and boiling point at normal or standard atmospheric pressure of many liquid volatile gas compounds. For example, if the boiling point of a volatile compound, substance or mixture is above that of the boiling point of the transport fluid (TF), and the freezing point of a more volatile gas, compound, substance or mixture (e.g., VG1, VG2) is lower than the boiling point of the transport fluid, then transport of the volatile gas liquid is enabled by use of the TF as an active or passive source of refrigeration such that the temperature of the volatile gas liquid may be maintained at or somewhat above the boiling point of the TF by boil-off or external refrigeration of the TF during transport or storage. In the rightmost column of FIG. 5 this condition is identified by those liquid volatile gases as “Liquid”. Pure compounds with a freezing point above that of the boiling point of methane would form solids and would not with certainty be transported in the liquid state. Pure compounds with a boiling point below that of the boiling point of methane would form gases and would not with certainty be transported in the liquid state.

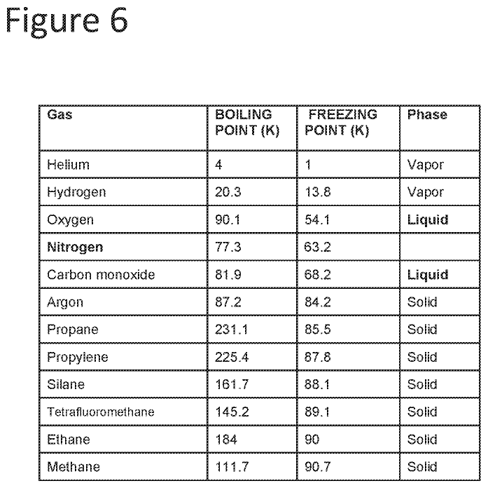

The exemplary concept described for LNG in FIG. 4 may be extended to other compounds, such as nitrogen, which can be transported as a cryogenic liquid, as shown further illustrated in FIG. 6. Employing nitrogen as the transport liquid (TF), the volatile gases (VG1, VG2) that can be co-transported as a liquid include oxygen and carbon monoxide. Further, compounds such as methane and ethane would solidify were nitrogen used solely as the transport liquid (TF). Therefore, in more general terms, if the boiling point of a volatile substance, compound or mixture in a volatile gas (e.g., VG1, VG2) is above that of a working constant temperature fluid compound or mixture that serves as the transport fluid (TF), and the freezing point of the volatile gas (VG1, VG2) is lower than that of a working constant temperature fluid compound or mixture that serves as the transport fluid, then transport of the volatile compound or mixture (VG1, VG2) as a liquid is enabled by use of the working constant temperature fluid acting as an active or passive source of refrigeration such that the temperature of the volatile gas, substance or mixture is maintained at or somewhat above the boiling point of the working constant temperature transport fluid compound or mixture during transport or storage. Use of liquid nitrogen as the transport fluid is advantageous when used as a boil off fluid as its release to the atmosphere does not result in increased carbon emissions nor release of combustible gases.

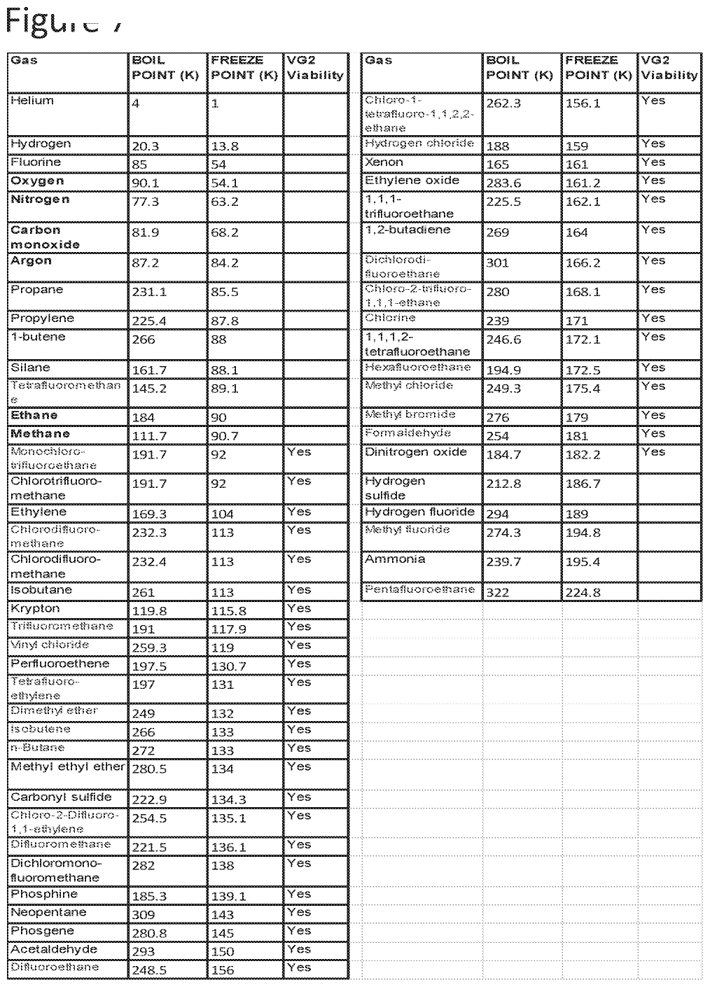

An example of fluid transport offers advantages for transporting select volatile gas liquids, but as shown in FIGS. 5 and 6, many compounds may be excluded if only LNG or methane and nitrogen are considered as adequate low value, low temperature boiling materials for co-transport of volatile compounds as liquids at or near the boiling temperature of the working constant temperature fluid. In some instances, using ethane as the transport liquid, for example, many more compounds become eligible for co-transport as liquids as is shown in FIG. 7. Because ethane boils at a higher temperature than methane at atmospheric pressure, higher temperature boiling compounds can be transported as a liquid using ethane as a working constant temperature fluid. Normally, ethane has much greater economic value than LNG or methane and would not be considered a material that one would desire to lose to boil-off or combustion as fuel, but many compounds, including several of those shown here, are normally much more valuable than ethane on a mass basis, and the financial loss of ethane could be offset by the ability to transport and not lose to boil off a much more valuable compound.

Some compounds are much less safe to transport in pressurized vessels due to the potential for unintentional depressurization release resulting in a hazard. In some instances, should pressure control fail to provide operating pressures within the normal operating pressure of the containment, especially for the situation where low pressures result from reduction of temperature in a closed vessel, an inert gas can be charged to the closed containment vessel to avoid vacuum conditions. The inert gas may be LNG vapors, volatile gas (VG1, VG2) vapors, nitrogen, an unreactive gas or a noble gas such as argon or helium. Example inert gases for maintaining pressure in a vessel include nitrogen, argon, methane, ethane, propane, helium, hydrogen, and oxygen without limitation.

Recent advances in gas exploration, including fracking, have resulted in greater availability of ethane at substantially lower cost, making ethane a reasonable choice as a heat transfer liquid or mixture component for more volatile compounds in some markets. In light of the advances in fracking, both ethane and methane are much more available in certain regions of the world where fracking is widely employed. In those regions, LNG and ethane transport are desirable and suitable for cryogenic transport as described above. Ethane and mixtures of ethane can be transported as a stable liquid near atmospheric pressure using methane or LNG as the lower economic value, lower boiling transport or sacrificial fluid, such as to boil off or combustion. Ethane, and several other compounds as shown in FIG. 7, can be maintained as a liquid at the normal boiling temperature of LNG or it can be maintained nearer to or at its boiling point at low pressure utilizing ordinary temperature control technology without the need for high pressure containment using active or passive flow control with heat exchangers in concert with a refrigeration apparatus the liquid ethane can be controlled to any temperature between the boiling point of the transport liquid and its own boiling point, which will be a result of the pressure maintained. Alternatively, employing ethane as an example only, the ethane can be allowed to heat to its boiling point and allowed to vaporize or even boil off as does LNG in typical LNG transport vessels. In another instance, the ethane boil-off gases can be recondensed by a heat exchanger wherein the cooling fluid is liquid LNG and the condensed ethane is returned to the ethane storage vessel.

A further advantage of allowing a first volatile gas (VG1) such as ethane to be transported at its boiling temperature, or substantially above the boiling temperature of the transport fluid is to allow a second and even more volatile gas compound or mixture (e.g., VG2) to be transported as a liquid at or near the maintained operating temperature of the ethane which, conversely, would not be a liquid at the temperature of boiling LNG transport (i.e., phosgene, ethylene oxide). Advantages of this method include avoiding storage of the volatile gas liquids (VG1, VG2) at elevated pressures and avoidance of the requirement of active refrigeration by standard refrigeration equipment including compressors.

The transport of materials that have economic value or are useful as conveyance heat transfer fluids, can be transported as liquids at pressure at temperatures at or below, and preferable significantly below local ambient temperature conditions are envisioned in this disclosure. Although ethane has been used as an example of a first volatile gas (VG1) which enables transport of a second volatile gas (VG2), other compounds, such as ethylene, which have a slightly lower boiling point than ethane, would serve to enable transport of some compounds that ethane does not. For example, propane has a much higher boiling point, yet a lower freezing point than ethane, and would have a wider range of applicability than ethane. In some cases, ethylene (VG1), would be co-transported relative to ethane (VG2) or other non-reactive refrigerant such that the ethylene transfers heat away from the ethane and the ethane transfers heat away from the second volatile gas, protecting the second volatile gas from direct contact with a potentially reactive first volatile gas. In some cases, it would be possible to have separate storage for the transport liquid, first volatile gas, and second volatile gas to enable transport of second volatile gas. In certain instances, during offloading one or more of these substances are allowed to be mixed such that the mixture is a valuable and salable commodity of a liquid volatile gas mixture. In some cases, it would be possible to transport the first and second volatile gases as a mixture that is easier and safer to transport, more valuable as a finished product, or more useful in a final processing step. Nonexclusive examples of such a situation may include transporting chemicals such as phosgene, phosphine, ethylene oxide or carbonyl sulfide solvated in ethane where the more volatile transported chemical will be reacted later to form new compounds while the ethane serves as its solvent. In some cases, it is possible that systems will include multiple transport fluids, and volatiles gases in order to convey multiple valuable gases from one or more export locations to one or more import locations using various disclosed heat transfer methods.

### Examples

1. Co-transporting argon using LNG by this method at standard pressure would not be directly useful. At atmospheric pressure, argon would form only a gas. Argon thus would not form a liquid at the boiling point of LNG because it boils at a lower temperature than the boiling point of LNG or methane. It is understood that low boiling compounds, substances or mixtures could be transported in pressurized containers at the boiling point of LNG which would lower their vapor pressure and enhance the safety of their transport. As an additional example, attempting to transport xenon using LNG by this method could result in the formation of solid xenon which could make heat transfer and movement of the compound out of its containment vessel problematic.

2. Ethylene oxide can form explosive clouds and phosgene can be highly toxic even in small doses. Recent advances in gas exploration, including fracking, have resulted in greater availability of ethane at substantially lower cost, making ethane a reasonable choice as a heat transfer liquid or mixture component for more volatile compounds in some markets. FIG. 7 lists as candidates for third liquid, signified by the term “YES” in the column labeled “Co-Transport as 3rd Liquid” in the case that methane or LNG is the first cryogenic liquid and ethane is the second cryogenic liquid. In this case, an acceptable condition for the third liquid is the third liquid temperature can be maintained below its boiling point but above its freezing point by liquid ethane which is maintained at or below its boiling point. As is evident, using ethane or similar substance as an intermediate heat transfer fluid greatly expands the number of liquids that can be transported using the first cryogenic liquid as a heat sink.

3. LNG is loaded onto a vessel capable of transporting LNG and other cargo and serves as the transport fluid as represented in FIG. 2. Liquid ethane is loaded into a separate containment and cooled to a temperature wherein the ethane does not boil at storage pressure, which in this case is chosen to be 1 atm to 1.35 atm (101.325 kPa to 136.789 kPa) for all fluids on the transport vessel. Therefore, LNG will be stored at approximately −161° C. (−258° F.) and the ethane will be stored below −89° C. (−128° F.). The high boiling liquid (VG2) is vinyl chloride, a recognized high volume commodity chemical used in diverse locations of the world to make polyvinyl chloride. The vinyl chloride freezes at −154° C. (−245° F.) and boils at −14° C. (7° F.) at atmospheric pressure. The vinyl chloride can be maintained as a liquid between those temperatures without pressure containment. A working temperature difference of at least 20° C. for each fluid to more easily accommodate standard heat transfer equipment will be used. The LNG maintains itself through boiling at −161° C. (−258° F.), the ethane is cooled by the LNG and maintained at −141° C. (−222° F.) and the vinyl chloride is maintained at −121° C. (−186° F.), which is significantly above its freezing point and well below its boiling point. Should the temperature difference drop between the ethane and the vinyl chloride, the minimum temperature that will be reached is −141° C. (−222° F.) which is above the freezing point of vinyl chloride. This is an example of one primary cryogenic liquid being used to maintain one secondary liquid in the liquid state which in turn is used to maintain a third substance in the liquid state that could not be reliably maintained in the liquid state, with freezing prevented, by heat transfer with the primary cryogenic liquid.

4. LNG is loaded onto a vessel capable of transporting LNG and other cargo, for example as represented in the configuration of FIG. 4. Liquid propane is loaded into a separate containment and cooled to a temperature wherein the propane does not boil at storage pressure, which in this case is chosen to be 1 atm to 1.35 atm (101.325 kPa to 136.789 kPa) for all fluids on the transport vessel. Therefore, LNG will be stored at approximately −161° C. (−258° F.) and the propane will be stored below −42° C. (−44° F.), its normal boiling point. The high boiling liquids (VG2s) will be ethylene oxide with a liquid state range between −111° C. (−168° F.) and 11° C. (12° F.), a recognized high volume commodity chemical used in diverse locations of the world to make polymers and various chemicals and phosgene, another high volume commodity chemical with a liquid state range of −128° C. (−198° F.) and 8° C. (46° F.) at atmospheric pressure. A useful working temperature for the propane could be 10° C. higher than the higher freezing temperature of the high boiling compounds, or −101° C. (−150° F.) so the ethylene oxide cannot freeze. Assuming a working temperature difference of at least 20° C. for each fluid, the ethylene oxide is maintained at −81° C. (−114° F.) and the phosgene is maintained at −81° C. (−114° F.). The LNG maintains itself through boiling at −161° C. (−258° F.), the propane is cooled by the LNG and maintained at −101° C. (−150° F.) and the high boiling compounds are maintained at −81° C. (−114° F.), which is significantly above their freezing points of −128° C. (−198° F.) and −111° C. (−168° F.), respectively and well below their boiling points of 11° C. (12° F.) and 8° C. (46° F.), respectively. As these chemicals are explosive and highly reactive, ethylene oxide, and highly toxic, phosgene, containment and isolation may be enhanced with double wall shells and/or pressure rated containment. This is an example of one primary cryogenic liquid being used to maintain one secondary liquid in the liquid state which in turn is used to maintain two separate substances in the liquid state that could not be reliably maintained in the liquid state, with freezing prevented, by heat transfer with the primary cryogenic liquid.

5. One desires to transport two reactants at atmospheric pressure, ethylene oxide and ammonia, to a manufacturing site to make a third chemical, ethanolamine. Ethylene oxide is a liquid between −111° C. (−168° F.) and 11° C. (12° F.) at atmospheric pressure. Ammonia is a liquid between −78° C. (−108° F.) and −33° C. (−27° F.) at atmospheric pressure. Therefore, the intermediate heat transfer liquid should be maintained at about −68° C. (−90° F.) to −45° C. (−49° F.), allowing for useful temperature differentials for effective heat transfer, while being liquid at −161° C. (−258° F.), the boiling point of LNG. Examples of compounds that are suited to this task are propane and propylene. Using propane due to its lower reactivity to either of these compounds, the propane may be operated at −68° C. (−90° F.) and the ammonia and ethylene oxide, contained in separate storage, maintained at −58° C. (−72° F.). For added safety, the propane may be maintained in separate storage chambers so that neither of the two reactive chemicals can come in contact with one another, such as through system leaks. This is an example of one primary cryogenic liquid being used to maintain one secondary liquid in the liquid state maintained in two separate storage vessels which in turn is used to maintain two separate substances in the liquid state that could not be reliably maintained in the liquid state, with freezing prevented, by heat transfer with the primary cryogenic liquid, and interaction of the third liquids minimized or eliminated.

6. R-134A is a liquid between −101° C. (−150° F.) and −27° C. (−17° F.). R-32 is a liquid between −137° C. (−215° F.) and −53° C. (−63° F.). One liquid is desired to maintain each liquid reliably in the liquid state and must operate between −101° C. (−150° F.) and −52° C. (−62° F.). Neither can be transported directly using LNG as the primary heat exchange fluid as each could freeze. Options for an intermediate heat transfer fluid between these refrigerants include propane, propylene and ethane among others, but a refrigerant such as R13 freezes at −181° C. (−294° F.) and boils at −81° C. (−114° F.), making it suitable as a single volatile component for first and second volatile gas if the R13 is operated at its boiling point and utilized as a standard refrigerant.

7. Oxygen and argon are both components of air, as is nitrogen, but nitrogen has the lowest economic value on a mass basis and liquid oxygen and liquid argon have greater value as industrial chemicals. As shown in FIG. 7, nitrogen which boils at 77.3K can be utilized to maintain oxygen and carbon monoxide as liquids at atmospheric pressure, but not argon, which would freeze at 84.2K. However, according to this invention, making nitrogen the transport fluid (TF), oxygen could be maintained as a liquid between 84.2K and 87.2K which is the liquid state range for argon and act as the second cryogenic liquid. Thereby, the oxygen could be used to maintain argon within the narrow temperature range it is a liquid as oxygen boils at 90.1K. Although not generally considered a high boiling liquid and not even the highest boiling liquid in this situation, argon is acted upon by oxygen in this manner due to oxygen's greater boiling range and suitability to serve as the intermediate liquid or first volatile gas.

8. Ethylene dichloride (EDC) can be made by reaction of ethylene and chlorine at modest temperatures as low as 20° C. (68° F.). To prevent the mixing of these reactants during transport, a separate substance can be used as a heat transfer medium, for example, ethane. In this scenario, LNG or methane is the TF that is allowed to boil off and provide ultimate cooling for all the system liquid components. Ethane's liquid state at atmospheric pressure ranges from 90K up to 184K. Ethylene's liquid state at atmospheric pressure ranges from 104K up to 169K. Chlorine's liquid state at atmospheric pressure ranges from 171K up to 239K. LNG is maintained at its boiling point of 111K. Ethylene will serve as the first volatile gas and will operate at 131K, exchanging heat with LNG. Ethane will serve as second volatile gas and will operate at 184K, its vaporization temperature, and exchange heat with ethylene. Although ethylene has a freezing point that is above that of ethane, neither liquid can fall below the boiling point of methane which sets the minimum temperature for the system, therefore assuring that neither chemical will freeze. Finally, the chlorine is the second volatile gas of the system, exchanges heat with boiling ethane, and is maintained above 184K. Chlorine temperature is allowed to operate between 184K and its boiling point of 239K.

9. Ethylene dichloride (EDC) can be made by reaction of ethylene and chlorine at modest temperatures as low as 20° C. (68° F.). To prevent the mixing of these reactants during transport, a separate substance can be used as a heat transfer medium, for example, ethane. Ethylene is transported by ship and maintained at its boiling point by refrigeration. Ethylene can serve as the TF if kept at or below its boiling temperature at operating pressure by use of an external method of cooling such as refrigeration. At atmospheric pressure, ethylene as the transport fluid will boil at 169K. Ethane's liquid state at atmospheric pressure ranges from 90K up to 184K. Chlorine's liquid state at atmospheric pressure ranges from 171K up to 239K. Maintaining ethane at 184K ensures chlorine does not freeze. Chlorine temperature is allowed to operate between 184K and its boiling point of 239K.

10. Ethylene freezes at 104K and boils at 169K at atmospheric pressure. Its freezing point is below methane's boiling point of 111K. LNG is loaded onto a vessel capable of transporting LNG and other cargo and serves as the transport fluid (TF). Liquid ethylene is subsequently cooled and loaded as a volatile gas liquid into a separate containment compartment that is thermally in contact with LNG wherein the ethylene does not boil at storage pressure, which in this case is chosen to be 1 atm to 1.35 atm (101.325 kPa to 136.789 kPa) for all fluids on the transport vessel. Therefore, LNG will be stored at approximately 111K, its boiling point, and the ethylene will be stored below 169K. Using heat exchange or thermal cascade, liquid ethylene is maintained at a temperature below its boiling point by cross exchange of heat with LNG. In this example there is no third liquid.

11. Propylene freezes at 88K and boils at 225K at atmospheric pressure. Its freezing point is below methane's boiling point of 111K. LNG is loaded onto a vessel capable of transporting LNG and other cargo and serves as the Primary Cryogenic Liquid as represented in FIG. 2. Liquid propylene is loaded into a separate containment and cooled to a temperature wherein the propylene does not boil at storage pressure, which in this case is chosen to be 1 atm to 1.35 atm (101.325 kPa to 136.789 kPa) for all fluids on the transport vessel. Therefore, LNG will be stored at approximately 111K, its boiling point, and the propylene will be stored below 225K. Using heat exchange or thermal cascade, liquid propylene is maintained at a temperature below its boiling point by cross exchange of heat with LNG. In this case, there is no third liquid.

12. Propylene freezes at 88K and boils at 225K at atmospheric pressure. It is loaded onto a cryogenic storage vessel and maintained at a temperature below its boiling point at operating pressure by use of a form of refrigeration and operates as the thermal transfer fluid or transport fluid. It is desired to co-transport three additional chemicals as liquids in separate storage: R134A a liquid in the range between 142K and 247K, ethylene oxide a liquid in the range between 161K and 283K, and ammonia a liquid in the range between 195K and 239K. For each substance to be maintained in the liquid state the propylene must operate at or above the highest freezing point of the three volatile gas materials and below the lowest boiling point of the three volatile gas materials. The propylene must be maintained between 195K and 238K. An additional 10° C. difference in temperature between the propylene and volatile gases is chosen to facilitate heat exchanger design. Therefore, maintaining the propylene between 205K and 228K will allow the propylene to effectively serve as a heat transfer medium for R134A, ethylene oxide and ammonia.

1. A method for storage and transporting gases, comprising:
charging a transport fluid to transport fluid system at cryogenic conditions;
charging a first volatile gas to a first volatile gas system;
maintaining the first volatile gas in a first liquid phase by heat transfer with the transport fluid,
charging a second volatile gas to a second volatile gas system;
maintaining the second volatile gas in a second liquid phase by heat transfer with the first volatile gas or transport fluid;
and transporting the first and second liquid phases.

2. The method of claim 1, wherein transport fluid comprises at least one component chosen from the group consisting of: oxygen, nitrogen, argon, liquid natural gas, methane, ethane, ethylene, propane, propylene and combinations thereof.

3. The method of claim 1, wherein the transport fluid is maintained at a temperature at a predetermined pressure by means of boiling.

4. The method of claim 1, wherein the transport fluid is maintained at a temperature at a predetermined pressure by applied external refrigeration.

5. The method of claim 1, wherein the first volatile gas comprises at least one gas component chosen from the group consisting of: oxygen, carbon monoxide, argon, propane, propylene, 1-butene, silane, tetrafluoromethane, ethane, methane, monochlorotrifluoroethane, chlorotrifluoromethane, ethylene chlorodifluoromethane, chlorodifluoromethane, isobutane, krypton, trifluoromethane, vinyl chloride, perfluoroethene, tetrafluoroethylene, dimethyl ether, isobutene, n-butane, methyl ethyl ether, carbonyl sulfide, chloro-2-difluoro-1,1-ethylene, difluoromethane, dichloromonoflurormethane, phosphine, neopentane, phosgene, acetaldehyde, difluoroethane, chloro-1-tetrafluoro-1,1,2,2-ethane, hydrogen chloride, xenon, ethylene oxide, 1,1,1-trifluoroethane, 1,2-butadiene, 1,3-butadiene, dichlorodifluoroethane, chloro-2-trifluoro-1,1,1-ethane, chlorine, 1,1,1,2-tetrafluoroethane, hexafluoroethane, methyl chloride, methyl bromide, formaldehyde, dinitrogen oxide, hydrogen sulfide, hydrogen fluoride, methyl fluoride, ammonia, pentafluoroethane and combinations thereof.

6. The method of claim 1, wherein the first volatile gas comprises a freezing point below the boiling point of the transport fluid and a boiling point above that of transport fluid at operating pressure.

7. The method of claim 1, comprising maintaining the first volatile gas temperature between the boiling point of the transport fluid and its boiling point at operating pressure.

8. The method of claim 1, wherein the second volatile gas comprises at least one gas component chosen from the group consisting of: oxygen, argon, propane, propylene, 1-butene, silane, tetrafluoromethane, ethane, methane, monochlorotrifluoroethane, chlorotrifluoromethane, ethylene, chlorodifluoromethane, chlorodifluoromethane, isobutane, krypton, trifluoromethane, vinyl chloride, perfluoroethene, tetrafluoroethylene, dimethyl ether, isobutene, n-butane, methyl ethyl ether, carbonyl sulfide, chloro-2-difluoro-1,1-ethylene, difluoromethane, dichloromonoflurormethane, phosphine, neopentane, phosgene, acetaldehyde, difluoroethane, chloro-1-tetrafluoro-1,1,2,2-ethane, hydrogen chloride, xenon, ethylene oxide, 1,1,1-trifluoroethane, 1,2-butadiene, 1,3-butadiene, dichlorodifluoroethane, chloro-2-trifluoro-1,1,1-ethane, chlorine, 1,1,1,2-tetrafluoroethane, hexafluoroethane, methyl chloride, methyl bromide, formaldehyde, dinitrogen oxide, hydrogen sulfide, hydrogen fluoride, methyl fluoride, ammonia, pentafluoroethane, and combinations thereof.

9. The method of claim 1, comprising maintaining the second volatile gas temperature at or below its boiling temperature and above its freezing temperature at operating pressure.

10. The method of claim 1, wherein the second volatile gas comprises a freezing point above the boiling point of at least one first cryogenic liquid and a boiling point at or lower than the boiling point of at least one second cryogenic liquid.

11. The method of claim 1, wherein second volatile gas has a freezing point above the boiling point of the transport fluid and a boiling point above the boiling point of the first volatile gas.

12. The method of claim 1, further comprising maintaining pressure in a storage vessel by the introduction of a gas comprising at least one from the group consisting of: nitrogen, argon, methane, ethane, propane, helium, hydrogen and oxygen.

13. The method of claim 1, comprising controlling the temperature in any system by using refrigeration, one or more evaporative coolers, one or more air coolers, one or more water coolers, auto-refrigeration, or gas-expansion.

14. A method for storage and transporting gases, comprising:
charging a transport fluid to a cryogenic system;
charging a volatile gas to a thermally regulated system;
maintaining the volatile gas in a liquid state by thermal cascade from the thermally regulated system to the cryogenic system by heat transfer;
and transporting the fluids at a predetermined pressure.

15. The method of claim 14, wherein the transport fluid comprises at least one component chosen from the group consisting of: oxygen, nitrogen, argon, liquid natural gas, methane, ethane, ethylene and combinations thereof.

16. The method of claim 14, wherein the temperature of the transport fluid is maintained at the boiling point at the predetermined pressure by boiling the transport fluid.

17. The method of claim 14, wherein the temperature of the transport fluid is maintained at the boiling point at the predetermined pressure by external refrigeration.

18. The method of claim 14, wherein the volatile gas comprises at least one component chosen from the group consisting of: oxygen, carbon monoxide, argon, propane, propylene, 1-butene, silane, tetrafluoromethane, ethane, methane, monochlorotrifluoroethane, chlorotrifluoromethane, ethylene chlorodifluoromethane, chlorodifluoromethane, isobutane, krypton, trifluoromethane, vinyl chloride, perfluoroethene, tetrafluoroethylene, dimethyl ether, isobutene, n-butane, methyl ethyl ether, carbonyl sulfide, chloro-2-difluoro-1,1-ethylene, difluoromethane, dichloromonoflurormethane, phosphine, neopentane, phosgene, acetaldehyde, difluoroethane, chloro-1-tetrafluoro-1,1,2,2-ethane, hydrogen chloride, xenon, ethylene oxide, 1,1,1-trifluoroethane, 1,2-butadiene, 1,3-butadiene, dichlorodifluoroethane, chloro-2-trifluoro-1,1,1-ethane, chlorine, 1,1,1,2-tetrafluoroethane, hexafluoroethane, methyl chloride, methyl bromide, formaldehyde, dinitrogen oxide, hydrogen sulfide, hydrogen fluoride, methyl fluoride, ammonia, pentafluoroethane and combinations thereof.

19. The method of claim 14, wherein the volatile gas has a freezing point below the boiling point of at least one first cryogenic liquid and a boiling point above that of at least one first cryogenic liquid at the predetermined pressure.

20. The method of claim 14, wherein the temperature of the volatile gas is maintained between the boiling point of the transport fluid and its boiling point at the predetermined pressure.
